(19) United States
(12) Patent Application Publication
(10) Pub. No.: US 2009/0145682 A1
(43) Pub. Date: Jun. 11, 2009

(54) PROPULSION DRIVE SYSTEM FOR A UTILITY VEHICLE

(76) Inventor: STEFAN BOHRER, ST. WENDEL (DE)

Correspondence Address: DEERE & COMPANY, ONE JOHN DEERE PLACE, MOLINE, IL, 61265, US

(21) Appl. No.: 12/327,388

(22) Filed: Dec. 3, 2008

(30) Foreign Application Priority Data
Dec. 6, 2007 (DE) 10 2007 058 535.9

(51) Int. Cl. B60K 6/08

(52) U.S. Cl. 180/305; 60/712

(57) ABSTRACT

A propulsion drive system is provided for a utility vehicle having an internal combustion engine, a hydraulic pump connected, so as to be driven by the internal combustion engine wherein the fluid displacement of the hydraulic pump can be varied by a first actuator. A hydraulic motor is connected by a line conducting hydraulic fluid to the hydraulic pump wherein the fluid displacement of the hydraulic motor can be varied by a second actuator and is connected so as to drive at least one propulsion device in engagement with the ground. A control arrangement is connected with a speed input arrangement. The control arrangement is operated so as to control the first actuator and the second actuator in such a way that the overall efficiency of the hydraulic pump and the hydraulic motor is at a maximum.

### FIELD OF THE INVENTION

The invention concerns a propulsion drive system for a utility vehicle having an internal combustion engine, a hydraulic pump in drive connection with the internal combustion engine, whose fluid displacement can be varied by a first actuator, a hydraulic motor connected to the hydraulic pump by a line conducting hydraulic fluid where the fluid displacement of the hydraulic motor can be varied by a second actuator and being connected so as to drive at least one propulsion device in engagement with the ground. A control arrangement is connected with the first actuator, the second actuator and a speed input arrangement arranged to generate a target speed signal which is connected and can be operated in such a way as to control the first actuator and the second actuator so that the propulsion device is driven at the target propulsion speed as provided as input by the speed input arrangement.

### BACKGROUND OF THE INVENTION

In many utility vehicles, such as agricultural vehicles and more particularly harvesting machines, hydraulic drives are being utilized. These drives include a hydraulic pump driven by an internal combustion engine and a hydraulic motor connected to the hydraulic pump by lines conducting hydraulic fluid so that the hydraulic motor drives one wheel or more wheels. In some vehicles the wheels of the front and rear axle are driven hydraulically by at least one hydraulic motor associated with the axles or the wheels.

A propulsion drive system of this kind is described by DE 102 11 799 A. Here the swash plate of the adjustable hydraulic pump is controlled by an actuator and a control arrangement controls it as a function of the position of the propulsion control lever adjusted by the operator, so that the hydraulic flow demanded by the increasing speed required by the operator is generated. Two adjustable hydraulic motors are associated in each case with the front or rear axle and also include adjustable swash plates controlled by actuators connected with the control arrangement. The position of the swash plates of the hydraulic motors is controlled on the basis of the output rotational speed of the hydraulic motors and the pressure difference between their inlet and outlet, so that in the case of spinning wheels or wheels rotating opposite to the desired direction the control arrangement can correct the rotation.

In the case of the drive system according to DE 102 11 799 A the disadvantage is seen in the fact that the efficiency of the hydraulic drive consisting of the hydraulic pump and the hydraulic motor is relatively poor, particularly in the lower speed range.

DE 103 50 308 A describes a process for the selection of the engine rotational speed and the gear ratio for a continuous hydrostatic torque division gearbox that includes a hydrostatic gearbox with a constant volume unit and an adjustable volume unit as well as a summing gearbox and an area gearbox with several selectable gear ratios, there the torque provided as input to the gearbox is divided between the hydrostatic gearbox and the area gearbox and is then combined in the summing gearbox. The engine rotational speed and the gear ratio of the torque division gearbox are controlled automatically in such a way that an optimum overall efficiency results in a desired speed. The gearbox described here includes only one adjustable hydraulic element (pump or motor), so that the engine rotational speed control must be utilized in order to fulfill the two conditions (attainment of the desired speed and attainment of the highest possible efficiency). Accordingly, this arrangement is not appropriate for self-propelled harvesting machines whose internal combustion engine is operated at a fixed predetermined rotational speed at least during the harvesting operation. Moreover, in contrast to the gearbox according to the class the torque division gearbox used here provides an additional mechanical branch.

### SUMMARY OF THE INVENTION

The purpose underlying the invention is seen in the need to make available an improved propulsion drive system for a utility vehicle that does not include the aforementioned problems.

The propulsion drive system of the utility vehicle, which in particular may be a self-propelled harvesting machine, includes an internal combustion engine. The internal combustion engine drives a hydraulic pump directly or indirectly, that is, via an intervening mechanical, hydraulic or any other desired gearbox. The hydraulic pump is connected with a hydraulic motor via a hydraulic line, the hydraulic motor mechanically drives a propulsion device in engagement with the ground, in particular a wheel or a crawler drive. The fluid displacement of the hydraulic pump and the hydraulic motor can be varied by a first actuator or a second actuator. A control arrangement is connected with both actuators and a speed input arrangement that provides a target speed signal which contains information regarding the desired target speed with which the utility vehicle is to be driven. The target speed input arrangement can be actuated by the operator or it operates automatically in order, for example, to attain a constant harvested crop throughput. The control arrangement has two degrees of freedom in order to attain the target speed, that is, the positions of the actuators with which the fluid displacement of the hydraulic pump and of the hydraulic motor can be varied. One of the degrees of freedom is established by the desired target speed, while the present invention proposes that the other degree of freedom be utilized in such a way that an optimum overall efficiency (that is, a maximum efficiency) of the hydraulic system consisting of the hydraulic pump and the hydraulic motor is attained. In this way the result is an improved efficiency of the drive system and a reduction of the fuel consumption.

In a further development the invention proposes that, in addition, the control arrangement be connected with an engine control arrangement of the internal combustion engine. The control arrangement also varies the rotational speed of the internal combustion engine in such a way that the overall efficiency of the entire propulsion drive system including the internal combustion engine is optimized.

Further input parameters that could be included here are the torque developed by the hydraulic motor as determined by means of a torque sensor that could be used to determine the rotational speed of the internal combustion engine required to deliver the necessary torque or power.

This variation of the rotational speed of the internal combustion engine is particularly useful during operation on public roads where a switch for the changeover between operation on a field and operation on public roads can be seen as particularly useful. On the other hand during operation on a field it is useful, as a rule, to control the rotational speed of the internal combustion engine by an operator and to hold it constant (or with an automatic control based on appropriate sensor values, for example, for the immediate harvested crop throughput) in order to make available appropriate rotational speeds for the operating devices of the operating machines, such as threshing and separating arrangements for combines or chopper and conveyor arrangements for forage harvesters.

The efficiency of hydraulic pumps and hydraulic motors is a function, in particular, of the pressure difference between the inlet and the outlet which, in turn, is a function of the fluid displacement that depends upon the position of the swash plate as controlled by the actuator. In general the efficiency of the hydraulic components increases with increasing pressure up to a specific value for the hydraulic pump or the hydraulic motor. Accordingly, a solution is to command the hydraulic pump and the hydraulic motor in such a way that they both operate at the highest efficiency and that the control arrangement be connected with a pressure sensor that is arranged to measure the pressure at the outlet side of the hydraulic pump, and adjusts the actuators in such a way that a pressure is attained at the pressure sensor at which the overall efficiency of the hydraulic pump and the hydraulic motor is at a maximum. This pressure can be stored in a memory arrangement connected with the control arrangement. Thus the fluid displacement is reduced starting from a maximum fluid displacement until the optimum pressure has been reached. Analogously the fluid L ( displacement is increased starting from a fluid displacement that is too low which brings about a pressure that is higher than the optimum pressure until the optimum pressure has been reached. This optimum pressure may be a function of the desired rotational speed of the hydraulic motor, so that the rotational speed of the hydraulic motor or the target speed can be utilized for the selection of the pressure. For this purpose appropriate curves, formulae or tables could be stored in a memory in the control arrangement and subsequently recalled.

Moreover the invention proposes that the torque developed by the hydraulic motor be detected by a torque sensor. This would permit situations to be recognized in which the pressure made available by the hydraulic pump is no longer sufficient to make the required torque available at the outlet of the hydraulic motor. In such cases in which the torque detected exceeds a threshold value, the control arrangement will induce the first and the second actuators to increase the fluid displacement of the hydraulic pump and the hydraulic motor in order to be able to make the required torque available (although at the cost of a lower efficiency). The pivot angle of the swash plate of the hydraulic pump can be repositioned up to the maximum possible value or to a lower value, but that may be sufficient to supply the required torque and that offers a better efficiency than the maximum pivot angle of the swash plate.

### BRIEF DESCRIPTION OF THE DRAWINGS

The embodiments of the invention shall be described in greater detail below with reference to the following drawings wherein:

FIG. 1 is a schematic arrangement for the propulsion drive system according to the invention; and,

FIG. 2 shows a flow chart according to which the control system of FIG. 1 operates.

### DESCRIPTION OF THE PREFERRED EMBODIMENT

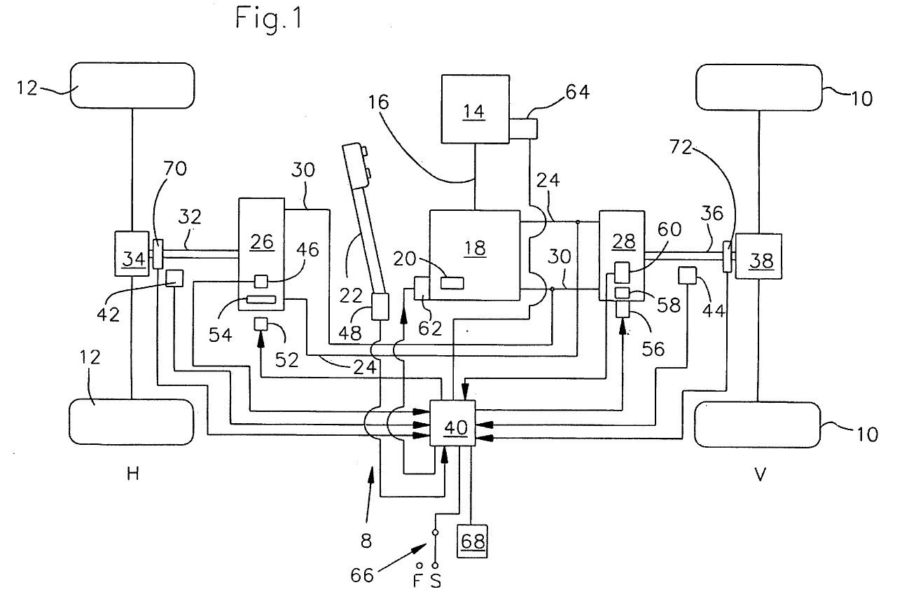

FIG. 1 schematically shows an embodiment of a propulsion drive system according to the invention. A utility vehicle 8 is provided with a frame (not shown) or a self-supporting chassis that is carried by front propulsion devices 10 and rear propulsion devices 12 in the form of wheels that are in engagement with the ground. As a rule the rear propulsion devices 12 can be steered while the front propulsion devices 10 are provided with a larger diameter than the rear propulsion devices 12 and support the larger part of the:weight of the utility vehicle 8, particularly if this is a harvesting machine in the form of a combine or a self-propelled forage harvester.

The propulsion drive system includes an internal combustion engine 14 in the form of a Diesel engine. The internal combustion engine 14 drives a hydraulic pump 18 via a shaft 16, the fluid displacement of the hydraulic pump can be varied by means of a swash plate 20, whose position can be controlled mechanically by a first actuator 62. The hydraulic pump 18 is provided with an outlet that is connected by lines 24 with the inlet of a first hydraulic motor 26 and the inlet of a second hydraulic motor 28. An inlet of the hydraulic pump 18 is connected with the outlet of the first hydraulic motor 26 and the outlet of the second hydraulic motor 28 via lines 30. In the case where the utility vehicle 8 is a self-propelled harvesting machine, the internal combustion engine 14 also drives its crop processing arrangements.

The first hydraulic motor 26 drives the two rear wheels 12 over a first drive shaft 32 and a first automatic differential gearbox 34. The second hydraulic motor 28 drives the two front wheels 10 over a second drive shaft 36 and a second automatic differential gearbox 38. The first hydraulic motor 26 may selectively be turned on and off, so that a four-wheel drive can be selected only in special operating conditions, in which a better traction capability is required. A shifted gearbox with various gear ratios that can be selected may be provided between the second hydraulic motor 28 and the second differential gearbox 38, this is not shown in FIG. 1 for reasons of clarity.

A control arrangement 40 is connected with a first rotational speed sensor 42, a second rotational speed sensor 44, and a first pressure sensor 46. The first rotational speed sensor 42 is arranged adjacent to the first drive shaft 32 and delivers an impulse at each revolution (or several times in each revolution) of the first drive shaft 32. It may include an optical or magnetic sensor that interacts with special markings or permanent magnets that are fastened to the first drive shaft 32. The second rotational speed sensor 44 is arranged adjacent to the second drive shaft 36 and delivers an impulse upon each rotation (or several times in each rotation) of the second drive shaft 36. It may include an optical or magnetic sensor that interacts with corresponding markings or permanent magnets, that are fastened to the second drive shaft 36. The pressure sensor 46 is arranged in the interior of the first hydraulic motor 26 and detects the pressure that exists at the outlet of the first hydraulic motor 26. A propulsion control lever position sensor 48 detects the position of the propulsion control lever 22 attached to the operator's station of the utility vehicle 8. The propulsion control lever position sensor 48 detects the actual position of the propulsion control lever 22 optically or magnetically.

The control arrangement 40 is connected with a second electromechanical actuator 52 that is arranged for the adjustment of a swash plate 54 of the first hydraulic motor 26. Information about the, position of the actuator 52 can be fed back to the control arrangement 40. If a stepper motor is used as actuator 52 this feedback becomes superfluous since the operating condition of the first hydraulic motor 26 has been determined.

The second rotational speed sensor 42 delivers a measured value regarding the rotational speed of the front wheels 10 to the control arrangement 40. In addition the first rotational speed sensor 42 delivers information regarding the rotational speed of the rear wheels 12 to the control arrangement 40.

The second hydraulic motor 28 is also provided with variable fluid displacement that is varied by a second electromechanical actuator 56 and an adjustable swash plate 58, and is associated with a second pressure sensor 60 that measures the pressure at the outlet of the second hydraulic motor 28. The control arrangement 40 is connected with the pressure sensor 60 and the actuator 56.

A first actuator 62 is provided that operates electromechanically or electro-hydraulically and is controlled by the control arrangement 40, it is used to adjust the swash plate 20 of the hydraulic pump 18. It is conceivable that the control arrangement 40 could be supplied, additionally with information regarding the immediate position of the first actuator 62. Such feedback, however, is not absolutely required, since a stepper motor could be used, and since the control arrangement has already received information by means of feedback regarding the operating condition of the hydraulic pump 18, particularly over the rotational speed sensors 42, 44 and the pressure sensors 46, 60. From the propulsion control lever position sensor 48 the control arrangement 40 receives a target speed signal regarding the position of the propulsion control lever 22 (used as speed input arrangement).

The internal combustion engine 14 is associated with an engine control arrangement 64 connected with the control arrangement 40, which determines the rotational speed of the internal combustion engine 14. A switch 66 connected with the control arrangement 40 is used for the changeover between operation on a field (position F) and operation on public roads (position S). Finally the control arrangement 40 is connected with an accumulator arrangement 68 and two torque sensors 70, 72 that detect the torque in the shafts 32 or 36.

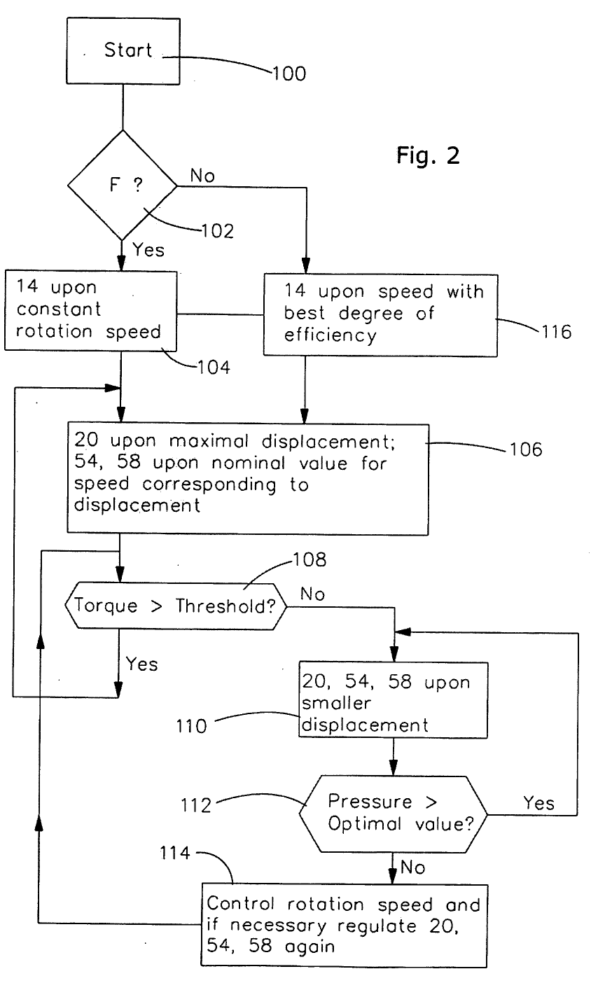

On the basis of the above configuration the method of operation of the control arrangement 40 of the propulsion drive system of the utility vehicle 8 is as shown in FIG. 2. If, after the start (step 100) the switch 66 is in the position for operation on a field (step 102), the control arrangement 40 induces the internal combustion engine 14 by means of the engine control arrangement 64 to rotate at a constant rotational speed that can be provided as input by the operator by means of a rotary knob (not shown) (step 104). Then the control arrangement 40 induces the first actuator 62 to move the swash plate 20 of the hydraulic pump 18 into a position of maximum fluid displacement, while the second actuators 52, 56 bring the swash plates of the hydraulic motors 26, 28 into a position that is a function of the target speed signal of the propulsion control lever position sensor 48 (step 106). Accordingly the utility vehicle 8 is moved in a direction of movement forward or reverse. The control arrangement 40 detects the measured values of the torque sensors 70, 72 and compares these with a threshold value stored in the memory arrangement 68 (step 108). If one of the torque values exceeds the threshold value, there is at first no further adjustment of the actuators 52, 56, 62, but instead the process is repeated (step 106).

If the torque values in the shafts 32, 36 are less than the threshold value there is the possibility of adjusting the swash plates 20, 54 and 58 to lower pivot angles that would permit a better efficiency of the hydraulic gearbox. Accordingly the first actuator 62 is induced to, adjust the swash plate 20 of the hydraulic pump 18 in a direction of lower fluid displacement and the second actuators 52, 56 are also induced by the control arrangement 40 to adjust the swash plates 54, 58 of the hydraulic motors 26, 28 in the direction of a lower fluid displacement (step 110). This readjustment is performed repeatedly until the pressures detected by means of the pressure sensors 46, 60 correspond to an optimum value which corresponds to a maximum efficiency of the hydraulic gearbox and is stored in memory in the memory arrangement 68 (step 112). Analogously at this point the control arrangement 40 can induce the actuators 62, 52, 56 to move the swash plates 20, 54, 58 in the direction of an increased fluid displacement when the pressure detected by the pressure sensors 46, 60 is greater than the optimum pressure and accordingly the efficiency is also not optimum.

During these readjustments the rotational speeds of the shafts 32, 36 should remain constant, a fact that the control arrangement 40 monitors by means of the rotational speed sensors 42, 44 and readjusts, if necessary, by means of the actuators 52, 56 (step 114). Accordingly the efficiency of the hydraulic gearbox is optimized. The control processes described here are repeated regularly (for example, every 0.1 sec.) (step 108).

If the switch 66 is in the position for operation on public roads (step 102), the control arrangement 40 controls and varies, in addition, the rotational speed of the internal combustion engine 14 by means of the engine control arrangement 64. Thereby the immediate power output of the internal combustion engine 14 is detected on the basis of its rotational speed (and/or on the basis of the measured value of the torque sensors 70, 72) and adjusted to a value at which the overall efficiency of the propulsion drive system including the internal combustion engine 14 and the hydraulic gearbox is at a maximum (step 116). At that point the swash plates 20, 54 and 56 are readjusted in a manner noted for operation on a field (step 106 etc.).

Having described the preferred embodiment, it will become apparent that various modifications can be made without departing from the scope of the invention as defined in the accompanying claims.

The invention claimed is:

1. A propulsion drive system for a utility vehicle having:
an internal combustion engine;
a hydraulic pump connected so as to be driven by the internal combustion engine and whose fluid displacement can be varied by a first actuator;
a hydraulic motor connected so as to conduct hydraulic fluid to the hydraulic pump whose fluid displacement can be varied by means of a second actuator and that is connected so as to drive at least one propulsion drive device in engagement with the ground; and,
a control arrangement that is connected with the first actuator, the second actuator and a speed input arrangement designed to generate a target speed signal, and that is operated so as to control the first actuator and the second actuator in such a way that the propulsion drive device is driven at the target speed provided by the speed input arrangement,
wherein the control arrangement is operated so that the first actuator and the second actuator are controlled in such a way that the overall efficiency of the hydraulic pump and the hydraulic motor is at a maximum.

2. A propulsion drive system according to claim 1, wherein the control arrangement is also connected to an engine control arrangement of the internal combustion engine and is operated so as to vary the rotational speed of the internal combustion engine in such a way that a maximum overall efficiency of the propulsion drive system is attained.

3. A propulsion drive system according to claim 2, wherein the control arrangement is connected with a switch for the changeover between operation on a field and operation on public roads and when the switch is set for operation on a field the rotational speed of the internal combustion engine is provided as a fixed input by an operator and is held constant, while when the switch is set for operation on public roads the rotational speed is varied by the control arrangement.

4. A propulsion drive system according to claim 1, wherein the control arrangement is connected with a pressure sensor arranged to detect the pressure at the outlet side of the hydraulic pump and is operated to adjust the actuator in such a way that a pressure can be attained at the pressure sensor at which the overall efficiency of the hydraulic pump and the hydraulic motor is at a maximum.

5. A propulsion drive system according to claim 4, wherein the control arrangement is connected with a torque sensor arranged to detect the torque delivered by the hydraulic motor and is operated so as to induce the first and the second actuator to bring about an increase in the fluid displacement of the hydraulic pump and the hydraulic motor when the signal of the torque sensor exceeds a threshold value and/or the inverse.

6. A utility vehicle having a propulsion drive system having:
an internal combustion engine;
a hydraulic pump connected so as to be driven by the internal combustion engine and whose fluid displacement can be varied by a first actuator;
a hydraulic motor connected so as to conduct hydraulic fluid to the hydraulic pump whose fluid displacement can be varied by means of a second actuator and that is connected so as to drive at least one propulsion drive device in engagement with the ground; and,
a control arrangement that is connected with the first actuator, the second actuator and a speed input arrangement designed to generate a target speed signal, and that is operated so as to control the first actuator and the second actuator in such a way that the propulsion drive device is driven at the target speed provided by the speed input arrangement,
wherein the control arrangement is operated so that the first actuator and the second actuator are controlled in such a way that the overall efficiency of the hydraulic pump and the hydraulic motor is at a maximum.

7. A utility vehicle according to claim 6, wherein the control arrangement is also connected to an engine control arrangement of the internal combustion engine and is operated so as to vary the rotational speed of the internal combustion engine in such a way that a maximum overall efficiency of the propulsion drive system is attained.

8. A utility vehicle according to claim 7, wherein the control arrangement is connected with a switch for the changeover between operation on a field and operation on public roads and when the switch is set for operation on a field the rotational speed of the internal combustion engine is provided as a fixed input by an operator and is held constant, while when the switch is set for operation on public roads the rotational speed is varied by the control arrangement.

9. A utility vehicle according to claim 6, wherein the control arrangement is connected with a pressure sensor arranged to detect the pressure at the outlet side of the hydraulic pump and is operated to adjust the actuator in such a way that a pressure can be attained at the pressure sensor at which the overall efficiency of the hydraulic pump and the hydraulic motor is at a maximum.

10. A utility vehicle according to claim 9, wherein the control arrangement is connected with a torque sensor arranged to detect the torque delivered by the hydraulic motor and is operated so as to induce the first and the second actuator to bring about an increase in the fluid displacement of the hydraulic pump and the hydraulic motor when the signal of the torque sensor exceeds a threshold value and/or the inverse.

11. A process for the operation of a propulsion drive system for a utility vehicle having an internal combustion engine, a hydraulic pump connected so as to be driven by an internal combustion engine and whose fluid displacement can be varied by a first actuator, a hydraulic motor connected to the hydraulic pump so as to conduct hydraulic fluid, whose fluid displacement can be varied by a second actuator and that is connected so as to drive at least one propulsion device in engagement with the ground, a control arrangement that is connected with the first actuator, the second actuator and a speed input arrangement designed for the generation of a target speed signal, the control arrangement controlling the first actuator and the second actuator in such a way that the propulsion device is driven at a target speed provided as input by the speed input arrangement, wherein the control arrangement controls the first actuator and the second actuator in such a way that the overall efficiency of the hydraulic pump and the hydraulic motor are at a maximum.
